(19) United States
(12) Patent Application Publication
(10) Pub. No.: US 2023/0196778 A1
(43) Pub. Date: Jun. 22, 2023

(54) FRAUDULENT ACT ESTIMATION DEVICE AND CONTROL PROGRAM THEREFOR AND FRAUDULENT ACT ESTIMATION METHOD

(71) Applicant: TOSHIBA TEC KABUSHIKI KAISHA, Tokyo (JP)

(72) Inventor: Daisuke MIYAGI, Fuji Shizuoka (JP)

(21) Appl. No.: 17/965,544

(22) Filed: Oct. 13, 2022

(30) Foreign Application Priority Data
Dec. 16, 2021 (JP) 2021-204287
Mar. 28, 2022 (JP) 2022-052150

(51) Int. Cl. G06V 20/52; G06T 7/70; G06Q 20/20; G08B 13/196

(52) U.S. Cl. CPC G06V 20/52; G06T 7/70; G06Q 20/206; G08B 13/196; G06T 2207/30232; G06T 2207/30168

(57) ABSTRACT

According to an embodiment, a fraudulent act estimation device includes a first acquiring unit, an action recognizing unit, a second acquiring unit, and an output unit. The first acquiring unit acquires operation information from commodity registration operation by a customer at a settlement terminal. The action recognizing unit recognizes an action of the customer at the settlement terminal. The second acquiring unit acquires a reliability degree for the action of the customer. The output unit outputs result information based on the operation information and the reliability degree.

### CROSS-REFERENCE TO RELATED APPLICATION

The present application is based upon and claims the benefit of priorities from Japanese Patent Application No. 2021-204287, filed on Dec. 16, 2021, and Japanese Patent Application No. 2022-052150, filed on Mar. 28, 2022, the entire contents of which are hereby incorporated by reference.

### FIELD

Embodiments described herein relate generally to a fraudulent act estimation device, a control program for a fraudulent act estimation device, and a fraudulent act estimation method.

### BACKGROUND

In recent years, in retail stores, such as a supermarket, a self-service POS (Point Of Sales) terminal has been attracting attention for possibly reducing personnel expenses and limiting the spread of infectious diseases. The self-service POS terminal is a settlement terminal with which a customer performs operations from commodity registration to payment for purchased commodities by himself or herself. In most cases, a monitoring camera is set in order to monitor the customer who operates such a self-service POS terminal.

In stores into which the self-service POS terminal and the monitoring camera have been introduced, various actions of a customer at the POS terminal may be recognized based on imaging data captured by the monitoring camera. For example, movements of the customer's hands while holding a purchased commodity may be monitored for fraudulent actions or the like. The presence or absence of a fraudulent act is determined based on the movements of the customer at the POS terminal. If it is determined that a fraudulent act is present, for example, notification to a store clerk or a warning at the self-service POS terminal are performed. Thus, if the customer's hand enters a blind spot of the monitoring camera, the hand is hidden by an object, or becomes invisible due to a change in an illumination state (lighting conditions), the action of the customer cannot be correctly recognized. Because recognition of this sort has low reliability, it is likely that a normal act of the customer will be erroneously determined as a fraudulent act. Furthermore, it is possible that a fraudulent act of a customer might erroneously be determined as a normal act. Accordingly, there has been a demand to avoid a situation in which, for example, a trouble with the customer occurs or trust in the store is deteriorated due to low reliability monitoring.

### BRIEF DESCRIPTION OF THE DRAWINGS

FIG. 1 is a system configuration diagram for a store into which a self-service POS terminal is introduced.

FIG. 2 is a diagram for explaining a positional relation between a self-service POS terminal and a camera.

FIG. 3 is a schematic diagram illustrating an example of a monitoring image displayed on a display of an attendant terminal.

FIG. 4 is a block diagram of a fraudulent act estimation device.

FIG. 5 is a schematic diagram illustrating an example of a data structure of an action file.

FIG. 6 is a schematic diagram illustrating an example of a time-series buffer.

FIG. 7 is a schematic diagram illustrating an example of an output table.

FIG. 8 is a flowchart for explaining functions of an action recognizing unit and a second acquiring unit.

FIG. 9 is a flowchart for explaining functions of an operation recognizing unit and a first acquiring unit.

FIG. 10 is a flowchart for explaining a function of a fraudulence estimating unit.

FIG. 11 is a flowchart for explaining a function of an output unit.

FIG. 12 is a schematic diagram for explaining another embodiment relating to action recognition.

### DETAILED DESCRIPTION

An object of embodiments is to provide a fraudulent act estimation device (and control program) and a fraudulent act estimation method that can appropriately take measures according to a determined level of reliability that a customer has committed a fraudulent act.

According to one embodiment, a fraudulent act estimation device includes a first acquiring unit, an action recognizing unit, a second acquiring unit, and an output unit. The first acquiring unit is configured to acquire operation information regarding a commodity registration operation at a settlement terminal by a customer based on information supplied from the settlement terminal to a display control device for a monitoring screen displayed on an attendant terminal. The action recognizing unit is configured to recognize actions of the customer who performs the commodity registration operation at the settlement terminal based on image data provided by a camera positioned to monitor the customer at the settlement terminal. The second acquiring unit is configured to calculate a reliability degree for a recognized action of the customer based on a recognition confidence for the recognized action in the image data. The output unit is configured to output result information based on the operation information and the reliability degree.

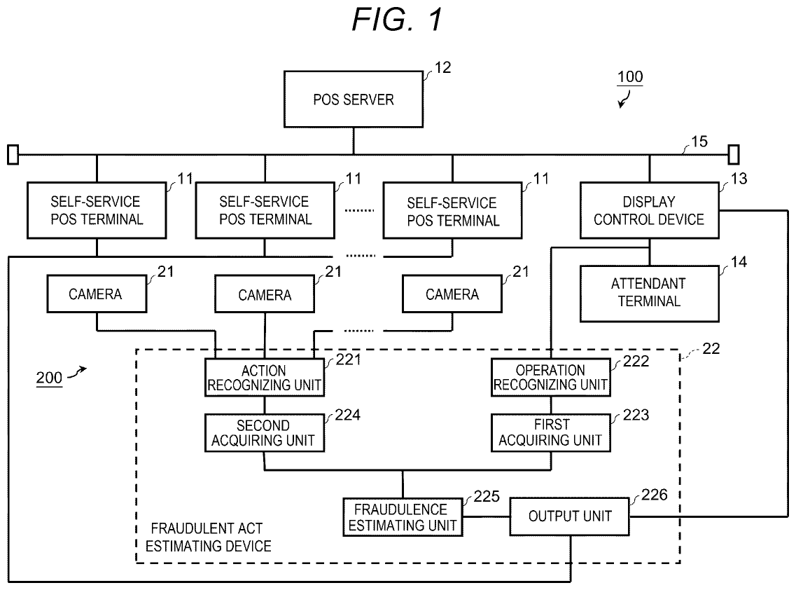

FIG. 1 is a system configuration diagram for a store into which a self-service POS terminal 11 has been introduced. This store system includes a self-service POS system 100 and a fraudulent act estimation system 200. The self-service POS system 100 includes a plurality of self-service POS terminals 11, a POS server 12, a display control device 13, an attendant terminal 14, and a communication network 15. The plurality of self-service POS terminals 11, the POS server 12, and the display control device 13 are connected to the communication network 15. The attendant terminal 14 is connected to the display control device 13. The communication network 15 is typically a LAN (Local Area Network). The LAN may be a wired LAN or may be a wireless LAN.

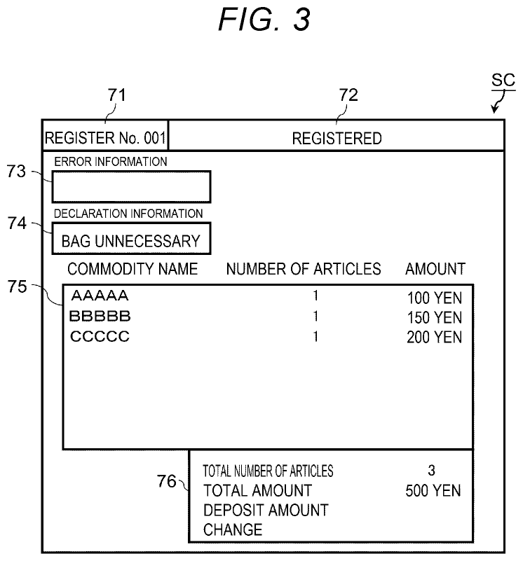

The self-service POS terminal 11 is a terminal adapted to a self-service with which a customer performs operations from registration to settlement of a purchased commodity by himself or herself. The customer is sometimes referred to as purchaser, consumer, client, or the like. The POS server 12 is a computer for centrally controlling or tracking the operations of the self-service POS terminals 11. The display control device 13 is a controller that generates a monitoring image SC (see FIG. 3) for each of the self-service POS terminals 11 based on various data signals output from the self-service POS terminals 11 and causes a display device of the attendant terminal 14 to display the monitoring image(s) SC. The attendant terminal 14 is a terminal for a store clerk (called an attendant in this context) to monitor states of the self-service POS terminals 11. The attendant terminal 14 includes a display such as a liquid crystal display or an organic EL display. The attendant terminal 14 divides a screen of the display into a plurality of sections and displays a different monitoring image SC in each of the sections. The attendant terminal 14 is an example of a store clerk terminal. As such a self-service POS system 100, a conventional self-service POS system of known type can be adapted.

The fraudulent act estimation system 200 includes a plurality of cameras 21 and a fraudulent act estimation device 22. The plurality of cameras 21 respectively correspond to the plurality of self-service POS terminals 11 in a one to one relation. Each camera 21 is a camera for imaging a customer who operates the self-service POS terminal 11 corresponding to the respective camera 21.

The fraudulent act estimation device 22 provides functions of an action recognizing unit 221, an operation recognizing unit 222, a first acquiring unit 223, a second acquiring unit 224, a fraudulence estimating unit 225, and an output unit 226. The action recognizing unit 221 has a function of recognizing, based on imaging data output from the cameras 21, an action of a customer who performs a commodity registration operation at a self-service POS terminal 11. The action recognizing unit 221 can also be referred as action recognizing means. The operation recognizing unit 222 has a function of recognizing, based on data of the monitoring image SC output from the display control device 13 to the attendant terminal 14, a commodity registration operation at a self-service POS terminal 11 by a customer. The operation recognizing unit 222 can also be referred to as operation recognizing means. The first acquiring unit 223 has a function of acquiring operation information for a recognized commodity registration operation. The first acquiring unit 223 can also be referred to as first acquiring means. The second acquiring unit 224 has a function of acquiring, based on a recognition result by the action recognizing unit 221, a reliability degree for the recognition result. The second acquiring unit 224 can also be referred to as second acquiring means. The fraudulence estimating unit 225 has a function of estimating a fraudulent act of a customer based on operation information acquired by the first acquiring unit 223 and a reliability degree acquired by the second acquiring unit 224. The fraudulence estimating unit 225 can also be referred to as fraudulence estimating means. The output unit 226 has a function of outputting estimated result information. The output unit 226 can also be referred to as output means.

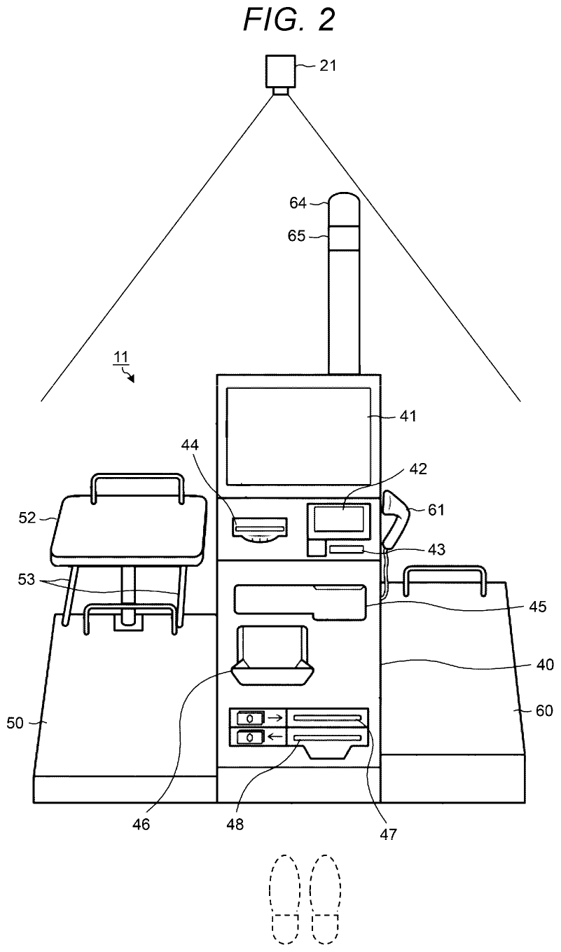

FIG. 2 is a diagram for explaining a positional relation between the self-service POS terminal 11 and the camera 21. First, an exterior configuration of the self-service POS terminal 11 is explained.

The self-service POS terminal 11 includes a main body 40 set on a floor surface and a bagging table 50 set beside the main body 40. A touch panel 41 is attached to an upper part of the main body 40. The touch panel 41 is configured by a display and a touch sensor. The touch panel 41 is an example of a display unit. The display is a device for displaying various screens to an operator who operates the self-service POS terminal 11. The touch sensor is a device for detecting a touch input to the screens by the operator. For the self-service POS terminal 11, the operator is usually a customer.

In the main body 40, a basket table 60 is provided on the opposite side of the bagging table 50. The basket table 60 is a table for a customer coming from a selling floor to place a basket (or the like) including commodities to be purchased. The customer stands on the near side of the main body 40 in FIG. 2 and performs work to be able to see a screen of the touch panel 41. Therefore, if viewed from the customer side, the basket stand 60 is present on the right side across the main body 40 from bagging table 50, which is present on the left side of the main body 40. In this embodiment, a side where the customer stands is referred to as the front of the main body 40, a side where the bagging table 50 is provided is referred to as the left side of the main body 40, and a side where the basket table 60 is provided is referred to as the right side of the main body 40.

The main body 40 includes a scanner, a card reader, a receipt printer, and a cash processing machine on the inside thereof. A reading window 42 of the scanner, a card inserting port 43, a receipt dispensing port 44, a coin depositing port 45, a coin dispensing port 46, a bill depositing port 47, and a bill dispensing port 48 are formed on the front surface of the main body 40. A communication cable extends from the right side surface of the main body 40 to the outside. A handy scanner 61 (hand-held scanner) is connected to the distal end of the communication cable. Although not separately illustrated, a reader writer for an electronic money medium can also be included in the main body 40.

A display pole 64 is attached to the upper surface of the main body 40. The display pole 64 includes a light emitting unit 65 at the distal end portion thereof. The light emitting unit 65 selectively emits, for example, blue light or red light. The display pole 64 displays a state of the self-service POS terminal 11, for example, standby, operating, calling, error, or fraudulent act occurring by variations in a light emission color or the like of the light emitting unit 65. The display pole 64 may display the state of the self-service POS terminal 11 with a flashing of the light emitting unit 65 or the like.

A bag holder 52 is attached to an upper part of the bagging table 50. The bag holder 52 includes a pair of holding arms 53. The bag holder 52 holds, with the pair of holding arms 53, a plastic shopping bag provided by the store or a shopping bag, that is, a reusable shopping bag provided by a customer.

As illustrated in FIG. 2, the camera 21 is set in a position where the camera 21 is capable of imaging a customer who stands in front of the self-service POS terminal 11 and faces components such as the main body 40, the bagging table 50, and the basket table 60.

First, the customer standing in front of the self-service POS terminal 11 places a basket or the like including commodities to be purchased on the basket table 60 and causes the holding arm 53 to hold a register bag, a reusable shopping bag, or the like. Subsequently, the customer operates the touch panel 41 and declares a use start of the self-service POS terminal 11 according to guidance displayed on the touch panel 41.

Thereafter, the customer picks up the commodities one by one from the basket placed on the basket table 60. If a barcode is attached to the purchased commodity, the customer holds the barcode over the reading window 42 and causes the scanner to read the barcode to perform commodity registration. If a barcode is not attached to the purchased commodity, the customer operates the touch panel 41 and selects the commodity from a list of commodities without barcodes to perform commodity registration. The customer puts the registered commodity in the register bag, the reusable shopping bag, or the like.

The customer who finishes registering all of the commodities operates the touch panel 41 and selects a settlement method. For example, if the customer selects cash payment, the customer deposits bills or coins in the bill depositing port 47 or the coin depositing port 45 and takes out change dispensed from the bill dispensing port 48 or the coin dispensing port 46. For example, if the customer selects electronic money settlement, the customer holds an electronic money medium over the reader writer. For example, if the customer selects credit card settlement, the customer inserts a credit card into the card inserting port 43. After finishing the settlement in this way, the customer receives a receipt dispensed from the receipt dispensing port 44 and leaves the store carrying the register bag or the reusable shopping bag removed from the holding arms 53.

In particular, the camera 21 is set in a position where the camera 21 is capable of imaging hand movements of the customer in front of the self-service POS terminal 11.

FIG. 3 is a schematic diagram illustrating an example of a monitoring image SC displayed on the display of the attendant terminal 14. As explained above, a monitoring image SC for each of the plurality of self-service POS terminals 11 is displayed on the display of the attendant terminal 14. FIG. 3 is an example of the monitoring image SC for one self-service POS terminal 11 among the plurality of self-service POS terminals 11. Since the configurations of the monitoring images SC for the other self-service POS terminals 11 are the same as the above, explanation of the configurations of the monitoring images SC is omitted.

As illustrated in FIG. 3, the monitoring image SC includes a register number field 71, a terminal state field 72, an error information field 73, a declaration information field 74, a details field 75, and a total field 76.

The register number field 71 is a field for displaying a register number. The register number is a series of numbers allocated to the self-service POS terminals 11 to individually identify the self-service POS terminals 11. The register number is identification information for identifying the self-service POS terminals 11.

The terminal state field 72 is a field for displaying an operation state of the self-service POS terminal 11. For example, any one of “standby”, “use start”, “registered”, “settlement start”, and “being settled” is displayed in the terminal state field 72 as the operation state.

The “standby” is a state from when the preceding customer finishes settlement until when a use start of the next customer is declared. An initial image is displayed on the touch panel 41 of the self-service POS terminal 11 that is in the state of “standby”. The initial image is, for example, an image including a touch button for causing a customer to select whether to use a register bag (store provided bag) or a reusable shopping bag.

The “use start” is a state in which the customer standing in front of the self-service POS terminal 11 declares a use start for settlement. For example, the customer performs, on the initial image, an operation for selecting whether to use the register bag or use the reusable shopping bag. This selection operation is taken as the declaration of the use start in this example. In response to the selection operation, the operation state of the self-service POS terminal 11 changes to the “use start” from “standby”.

The “registered” is a state in which registration operation for a commodity is being received. After a first item is registered, the operation state of the self-service

POS terminal 11 changes to the “registered” from “use start”. Thereafter, the operation state of the self-service POS terminal 11 maintains the “registered” until a shift to settlement is declared.

The “settlement start” is a state in which the customer finishing the registration of the commodities declares a shift to settlement. A soft key of [checkout] is displayed on the touch panel 41 of the self-service POS terminal 11 that is in the state of “registered”. The customer finishing the registration of the purchased commodity touches the soft key of [checkout]. This operation is a declaration of a shift to settlement. In response to this operation, the operation state of the self-service POS terminal 11 changes to the “settlement start” from “registered”.

The “being settled” is a state in which settlement processing such as cash settlement, electronic money settlement, or credit card settlement is being executed. For example, if bills or coins are deposited in the bill depositing port 47 or the coin depositing port 45, the operation state of the self-service POS terminal 11 changes to the “being settled” from “settlement start”. Once the settlement processing is finished, the operation state of the self-service POS terminal 11 returns to “standby”.

The error information field 73 is a field for displaying information concerning an error that may have occurred at the self-service POS terminal 11. The error may be a communication error, a receipt paper exhaustion error, or the like. The declaration information field 74 is a field for displaying declaration operation content from the customer. For example, if the customer selects the reusable shopping bag, “bag unnecessary” indicating that the register bag is unnecessary is displayed.

The details field 75 is a field for displaying details information of a commodity registered at the self-service POS terminal 11. The details information is, for example, a commodity name, the number of articles, and a price for the commodity. The total field 76 is a field for displaying total information of commodities registered at the self-service POS terminal 11. The total information is a total number of articles, a total amount due, a deposit amount, change returned, and the like.

The configuration of the monitoring image SC is not limited to the above. Fields in which other items are displayed may be arranged in the monitoring image SC. Items of text data displayed in FIG. 3 are not limited to the above. Text data of other items may be displayed.

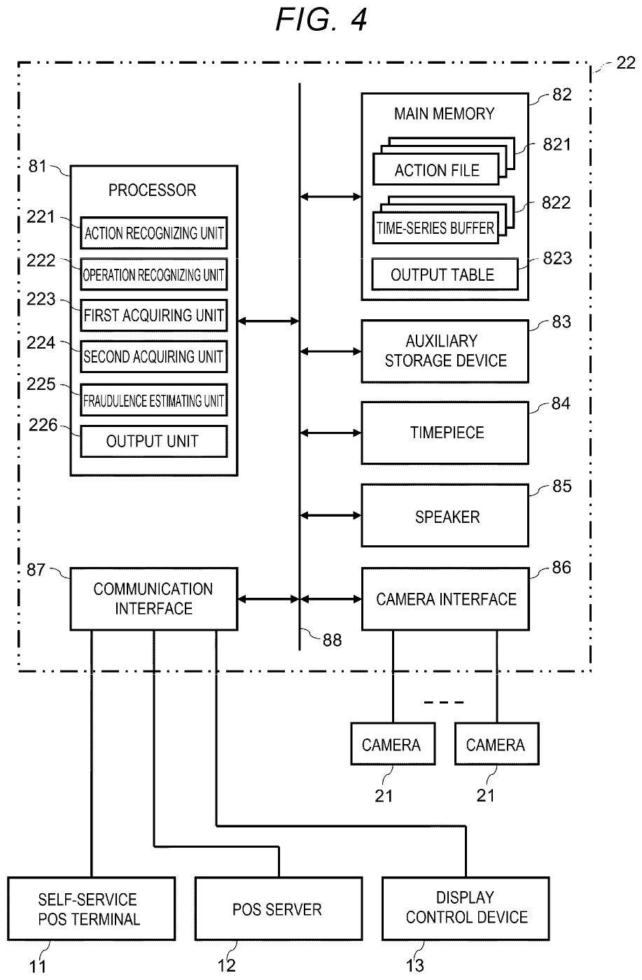

FIG. 4 is a block diagram of the fraudulent act estimation device 22. The fraudulent act estimation device 22 includes a processor 81, a main memory 82, an auxiliary storage device 83, a timepiece 84 (clock), a speaker 85, a camera interface 86, a communication interface 87, and a system bus 88. The system bus 88 includes an address bus and a data bus. The processor 81, the main memory 82, the auxiliary storage device 83, the timepiece 84, the speaker 85, the camera interface 86, and the communication interface 87 are connected by the system bus 88.

The processor 81 controls the units to realize various functions of the fraudulent act estimation device 22 according to an operating system and/or application programs. The processor 81 is, for example, a CPU (Central Processing Unit).

The main memory 82 includes a nonvolatile memory region and a volatile memory region. The main memory 82 stores the operating system or the application programs in the nonvolatile memory region. The main memory 82 stores, in the volatile memory region, data necessary for the processor 81 in executing processing for controlling the units. The data of this type is sometimes stored in the nonvolatile memory region. The main memory 82 uses the volatile memory region as a work area where data is rewritten as appropriate by the processor 81. The nonvolatile memory region is, for example, a ROM (Read Only Memory). The volatile memory region is, for example, a RAM (Random Access Memory).

As the auxiliary storage device 83, for example, a storage device such as an SSD (Solid-State Drive), an HDD (Hard Disc drive), or an EEPROM® (Electric Erasable Programmable Read-Only Memory) can be used or a plurality of storage devices can be used in combination. The auxiliary storage device 83 saves, for example, data used by the processor 81 in performing various kinds of processing and data generated by the processing in the processor 81. The auxiliary storage device 83 sometimes stores the application programs.

The application programs stored by the main memory 82 or the auxiliary storage device 83 include a control program explained below. A method of installing the control program in the main memory 82 or the auxiliary storage device 83 is not particularly limited. The control program can be recorded in a non-transitory, removable recording medium or can be distributed via a network and installed in the main memory 82 or the auxiliary storage device 83. The format of the recording medium does not matter so long as the recording medium can store programs and can be read by a device like a CD-ROM and a memory card.

The timepiece 84 functions as a time information source of the fraudulent act estimation device 22. The processor 81 acquires the present date and time based on time information provided by the timepiece 84.

The speaker 85 is an output device for outputting “sound data”. The “sound data” may include sound (tones, beeps, buzzes) or voice (speech).

The camera interface 86 is an interface for communicating with the cameras 21. Imaging data output from the cameras 21 are taken into the fraudulent act estimation device 22 via the camera interface 86. The imaging data includes captured videos and/or captured still images obtained by imaging customers who operate the self-service POS terminals 11 corresponding to the cameras 21.

The communication interface 87 is an interface for performing data communication with the self-service POS terminals 11, the POS server 12, the display control device 13, and the like according to a communication protocol. For example, image data output from the display control device 13 is taken into the fraudulent act estimation device 22 via the communication interface 87. The image data is data of the monitoring image SC generated for each of the self-service POS terminals 11.

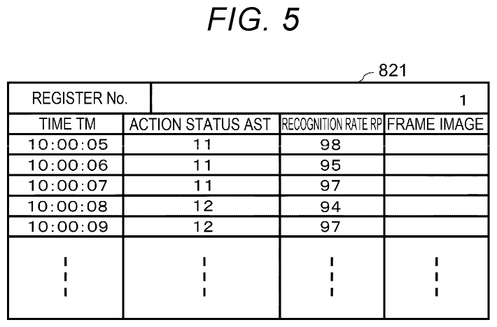

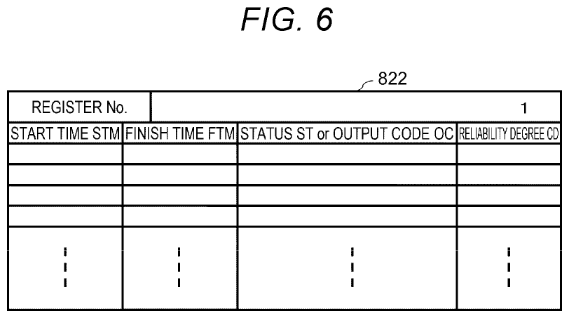

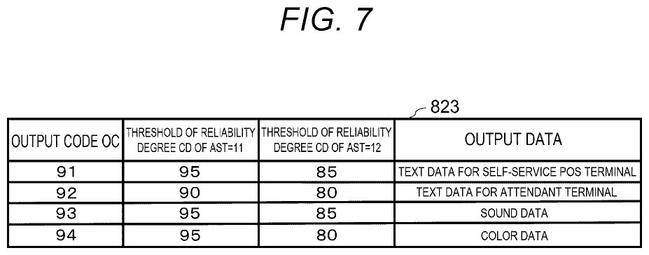

The fraudulent act estimation device 22 having such a configuration uses a part of the volatile memory region in the main memory 82 as a region of an action file 821 (see FIG. 5), a time-series buffer 822 (see FIG. 6), and an output table 823 (see FIG. 7). The fraudulent act estimation device 22 forms the action file 821, the time-series buffer 822, and the output table 823 in this region.

FIG. 5 is a schematic diagram illustrating an example of a data structure of the action file 821. As illustrated in FIG. 5, the action file 821 is a data file in which a time TM, an action status AST, a recognition rate RP, and a frame image are recorded in correlation with one another for each register number (identifying the self-service POS terminal 11). The time TM is a point in time when the action status AST was acquired. The action status AST represents a state in which an action of a customer was recognized by the function of the action recognizing unit 221 of the processor 81. In this embodiment, the recognized actions of the customer are a taking-out action and a bagging action.

The taking-out action is an action of taking out a commodity from a basket placed on the basket table 60. For example, if detecting a movement of a skeleton of one hand or both hands moving to the right side of the main body 40 and lifting a commodity, the processor 81 recognizes that the taking-out action is performed.

The bagging action is an action of putting a commodity for which registration is completed in a register bag, a reusable shopping bag, or the like on the bagging table 50. If detecting a movement of the skeleton of the hand that performs a registering action moving to the left side of the main body 40 and putting the commodity in the register bag, the reusable shopping bag, or the like, the processor 81 recognizes that the bagging action is performed.

The recognition rate RP is a numerical value calculated by the processor 81 representing a confidence level or the like that an action of a customer notionally recognized in a captured image (frame) as a taking-out action or a bagging action is in actuality a taking-out action or a bagging action. The recognition rate RP is, for example, a percentage value such that “1” represents complete confidence (certainty) the action is actually as recognized and “0” represent no confidence the action is actually as recognized. The recognition rate RP may be based on such things image analysis, a comparison to a reference image, or the like.

The frame image is an individual captured image captured by the camera 21 in a sequence of captured images provided by the camera 21 (e.g., frames of video, still images taken at fixed intervals, or the like). Frame images are recorded in the action file 821 in the order of acquisition. Items displayed in FIG. 5 are not limited to the above. Other items may be displayed. Content of text data displayed in FIG. 5 is an example.

FIG. 6 is a schematic diagram illustrating an example of the time-series buffer 822. As illustrated in FIG. 6, the time-series buffer 822 is a buffer including a region for describing, for each register number, start time STM, finish time FTM, a status ST or an output code OC (see FIG. 7), and a reliability degree CD in correlation with one another.

The start time STM is the earliest time TM for which the action status AST is described in the action file 821. The start time STM a point in time when an operation status HST was acquired. The start time STM is a point in time when the output code OC was acquired. The finish time FTM is the latest time TM for which the action status AST is described in the action file 821.

The status ST includes the action status AST and the operation status HST. The operation status HST represents a state in which commodity registration operation at the self-service POS terminal 11 by a customer is recognized by the function of the operation recognizing unit 222 of the processor 81.

The reliability degree CD is a level of reliability of a result of the processor 81 in recognizing an action of a customer. The reliability degree CD may be considered as a confidence level, a degree of confidence, or the like in the recognition of the particular action of the customer. The reliability degree CD is a numerical value calculated based on the recognition rate RP of a frame or the recognition rates RP of series of frames. The reliability degree CD is, for example, a percentage. The reliability degree CD is an example of a reliability degree for an action of a purchaser.

In the time-series buffer 822, the status ST or the output code OC and the reliability degree CD are listed in the ascending order of the start time STM. In this embodiment, if the action status AST is listed as the status ST, the start time STM, the finish time FTM, and the reliability degree CD are also listed. If the operation status HST or the output code OC is listed as the status ST, the start time STM is described and, for example, NULL values are listed in the finish time FTM and the reliability degree CD. Items included in the time-series buffer 822 are not limited to the above examples. Other items may be displayed.

FIG. 7 is a schematic diagram illustrating an example of an output table 823. As illustrated in FIG. 7, the output table 823 is a data table in which the output code OC, a threshold of the reliability degree CD of the action status AST “11”, a threshold of the reliability degree CD of the action status AST “12”, and output data are described in correlation with one another.

The output code OC is unique output identification information identified by the threshold of the reliability degree CD of the action status AST “11”, the threshold of the reliability degree CD of the action status AST “12”, and the output data in the same row. The action status AST “11” indicates a taking-out action. The action status AST “12” indicates a bagging action.

It is arbitrary how to set the threshold of the reliability degree CD of the action status AST “11” and the threshold of the reliability degree CD of the action status AST “12”. The thresholds may be fixed numerical values in the fraudulent act estimation device 22 or may be changeable to desired thresholds by the store. In this embodiment, the store sets the threshold of the reliability degree CD of the action status AST “11” and the threshold of the reliability degree CD of the action status AST “12” in advance. In some examples, the threshold may comprise a range of values (high threshold and low threshold) or the threshold may be a specific value. The thresholds are examples of predetermined conditions.

The output data is output to the self-service POS terminal 11 or the attendant terminal 14 if the threshold for the reliability degree CD of the action status AST “11” and of the action status AST “12” in the same row are both satisfied. The output data is, for example, “text data for self-service POS terminal” (e.g., a message to be displayed at the self-service POS terminal), “text data for attendant terminal” (e.g., a message to be displayed at the attendant terminal), “sound data” (e.g., a request or instruction to output a sound or voice message), or “color data” (e.g., lamp light color instructions).

The “text data for self-service POS terminal” is, for example, a message “there is a purchased commodity not registered”. The other messages for notifying a fraudulent act to a customer may be adopted. The “text data for self-service POS terminal” is an example of result information. The “text data for self-service POS terminal” is one example of information for making a fraudulent act known.

The “text data for attendant terminal” is, for example, a message “a fraudulent act is committed in a register of a register No. X”. The “text data for attendant terminal” is another example of the result information. The “text data for attendant terminal” is another example of the information for making a fraudulent act known.

The “sound data” may be, for example, an instruction, request, or command for a continuous sound or intermittently repeated sound. The “sound data” may be, for example, a voice message “there is a purchased commodity not registered”. The “sound data” is another example of the result information.

The “color data” is, for example, a command, instruction, or request to emit light of a specific color, change an emission from one color to another. For example, the “color data” is used for making a fraudulent act of the customer known to the attendant. The “color data” is another example of the result information.

In this embodiment, the store sets the various possible output data types in advance. The output data may include, for example, an output destination (address) and being in various formats specifically relating to a particular output method.

As illustrated in FIG. 7, for example, if the reliability degree CD of the action status AST “11” is 95 or higher and the reliability degree CD of the action status AST “12” is 85 or higher, the “text data for self-service POS terminal” and the “sound data” corresponding to the output codes OC “91” and “93” are both output as the output data. Output data of different types may be output individually or a as combination of a plurality of output data types according to settings of the thresholds of the reliability degree CD of the action status AST “11” and the action status AST “12”. Items displayed in FIG. 7 are not limited to the above. Other items may be displayed. Content of the text data displayed in FIG. 7 is an example.

The functions of the action recognizing unit 221, the operation recognizing unit 222, the first acquiring unit 223, the second acquiring unit 224, the fraudulence estimating unit 225, and the output unit 226 of the fraudulent act estimation device 22 are functions included for each of the self-service POS terminals 11. The functions of the action recognizing unit 221, the operation recognizing unit 222, the first acquiring unit 223, the second acquiring unit 224, the fraudulence estimating unit 225, and the output unit 226 for the other self-service POS terminals 11 are the same. The fraudulent act estimation device 22 realizes the functions of the action recognizing unit 221, the operation recognizing unit 222, the first acquiring unit 223, the second acquiring unit 224, the fraudulence estimating unit 225, and the output unit 226 with the processor 81 and a control program for controlling the processor 81.

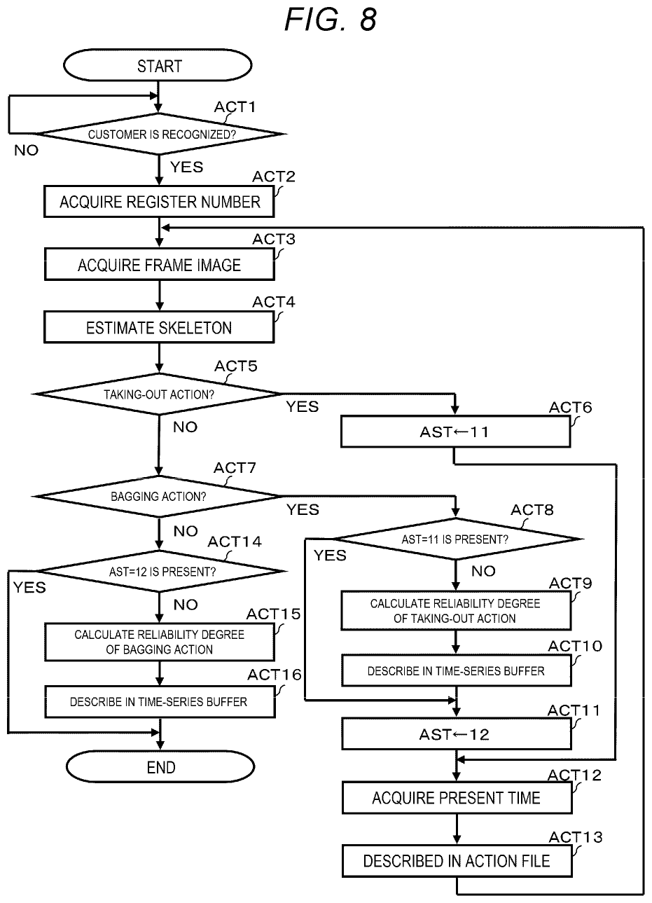

FIGS. 8 to 11 are flowcharts illustrating aspects of a control procedure of the processor 81 in the fraudulent act estimation device 22. In the following explanation, a system of a store into which the self-service POS terminal 11 is introduced is explained with reference to the flowcharts. The operation explained below is one example. The procedure of the operation is not particularly limited so long as the same results are obtained.

FIG. 8 is a flowchart for explaining the functions of the action recognizing unit 221 and the second acquiring unit 224.

In ACT 1, the processor 81 is waiting for the presence of a customer to be recognized. The camera 21 is set in a position where the camera 21 is capable of imaging a customer standing in front of the self-service POS terminal 11. Therefore, if detecting from a captured video of the camera 21 that a person stands in front of the self-service POS terminal 11, the processor 81 determines that a customer has been recognized.

If the customer is recognized, the processor 81 determines YES in ACT 1 and proceeds to ACT 2. In ACT 2, the processor 81 acquires a register number of the self-service POS terminal 11 at which the customer is present. In the present example, cameras 21 correspond to the self-service POS terminals 11 in a one to one relation. Therefore, the processor 81 identifies the self-service POS terminal 11 from identification information for the camera 21 that is imaging the customer standing in front of the self-service POS terminal 11 and acquires a register number of the self-service POS terminal 11 in this manner.

In ACT 3, the processor 81 starts acquisition of a frame image captured by the camera 21. Every time the processor 81 acquires a frame image, the processor 81 saves the frame image in the action file 821.

In ACT 4, the processor 81 estimates a skeleton of the customer. That is, the processor 81 performs an analysis to identify body positions (particularly hand/arm positions) of the person in the frame image captured by the camera 21. The skeleton estimation may be realized by an inexpensive camera 21 by using an artificial intelligence (AI) technology such as deep learning (or the like). The processor 81 recognizes a taking-out action or a bagging action of the customer from a movement of a hand as obtained by the skeleton estimation and changes in relative positions of aspects in the different frames over time. For example, such things the movement of a hand within the camera image field, distances between a hand and a region of interest (ROI) corresponding to, for example, the main body 40, the bagging table 50, or the basket table 60 may be detected or measured. The processor also calculates a recognition rate RP for the taking out motion or the bagging motion. Specifically, in this example, the processor 81 calculates, from the movements of the hand, a recognition rate for recognition of the taking-out action and a recognition rate for recognition of the bagging action. The processor 81 selects, as the recognition rate RP, the highest recognition rate among the recognition rates for different actions. For example, if the recognition rate of the taking-out action is 98 percent but the recognition rate of the bagging action is 2 percent, the recognition rate RP is taken as 98 percent. Thus, the processor 81 recognizes here the taking-out action as the action of the customer since the recognition rate RP of 98 percent was calculated for this action (as compared to 2 percent for the other action type). Since calculation processing for the recognition rate RP based on the movement of the hand is existing processing and well-known, additional explanation of the calculation processing is omitted in this example.

In ACT 5, the processor 81 checks, based on the processing in ACT 4, whether the taking-out action has been recognized. If the taking-out action is recognized (as function of the action recognizing unit 221), the processor 81 determines YES in ACT 5 and proceeds to ACT 6.

In ACT 6, the processor 81 sets the action status AST to “11”. Thereafter, the processor 81 proceeds to processing in ACT 12.

In ACT 12, the processor 81 acquires the present time TM clocked by the timepiece 84. In ACT 13, the processor 81 lists, in the action file 821 in which the register number acquired by the processing in ACT 2 is set, the time TM, the action status AST “11”, and the recognition rate RP calculated by the processing in ACT 4 in correlation with one another to correspond to one frame image saved by the processing in ACT 3. Thereafter, the processor 81 returns to ACT 3.

If a taking-out action is not recognized at ACT 5, the processor 81 determines NO in ACT 5 and proceeds to ACT 7.

In ACT 7, the processor 81 checks, based on the processing in ACT 4, whether a bagging action is recognized.

If the bagging action is recognized (as a function of the action recognizing unit 221), the processor 81 determines YES in ACT 7 and proceeds to ACT 8.

In ACT 8, the processor 81 checks whether “11” is described as the action status AST together with the start time STM, the finish time FTM, and the reliability degree CD in the time-series buffer 822 in which the register number acquired by the processing in ACT 2 is set.

If “11” is not described in the time-series buffer 822 as the action status AST, the processor 81 determines NO in ACT 8 and proceeds to ACT 9.

In ACT 9, the processor 81 (functioning as the second acquiring unit 224) calculates the reliability degree CD based on the recognition rate RP for the action status AST “11” described in the action file 821. For example, the processor 81 extracts the highest recognition rate RP out of one or a plurality of recognition rates RP for which the value “11” is listed as the action status AST. The processor 81 sets the highest recognition rate RP as the reliability degree CD of the taking-out action. A high reliability degree CD for the taking-out action means that reliability of a recognition result by the processor 81 for the taking-out action is considered high. That is, it considered highly likely that the customer actually performed the taking-out action. A low reliability degree CD for the taking-out action means that reliability of a recognition result by the processor 81 for the taking-out action is considered low. That is, it is uncertain (or at least is not highly likely) that the customer actually performed the taking-out action.

In ACT 10, the processor 81 lists “11” (as the action status AST) in the time-series buffer 822 together with the start time STM, the finish time FTM, and the reliability degree CD. The start time STM is the earliest time TM when “11” was listed in the action file 821 as the action status AST. The finish time FTM is the latest time TM when “11” is listed in the action file 821 as the action status AST. Thereafter, the processor 81 proceeds to ACT 11.

If “11” is in the time-series buffer 822 as the action status AST, the processor 81 determines YES in ACT 8, skips the processing in ACT 9 and ACT 10, and proceeds to ACT 11.

In ACT 11, the processor 81 sets the action status AST to “12”.

In ACT 12, the processor 81 acquires the present time TM clocked by the timepiece 84. In ACT 13, the processor 81 lists, in the action file 821, the time TM, the action status AST “12”, and the recognition rate RP calculated by the processing in ACT 4 in correlation with one another to correspond to the frame image saved by the processing in ACT 3. Thereafter, the processor 81 returns to ACT 3.

If the bagging action is not recognized, the processor 81 determines NO in ACT 7 and proceeds to ACT 14. In ACT 14, the processor 81 checks whether “12” is listed in the time-series buffer 822 as the action status AST together with the start time STM, the finish time FTM, and the reliability degree CD.

If “12” is not listed in the time-series buffer 822 as the action status AST, the processor 81 determines NO in ACT 14 and proceeds to ACT 15.

In ACT 15, the processor 81 calculates, referring to the action file 821 by the function of the second acquiring unit 224, the reliability degree CD based on the recognition rate RP at which “12” is listed as the action status AST. For example, the processor 81 extracts the highest recognition rate RP out of one or a plurality of recognition rates RP at which “12” is listed as the action status AST. The processor 81 sets the highest recognition rate RP as the reliability degree CD of the bagging action. High reliability degree CD of the bagging action means that reliability of a recognition result of the bagging action by the processor 81 is high, that is, reliability that the customer performed the bagging action is high. Low reliability degree CD of the bagging action means that reliability of a recognition result of the bagging action by the processor 81 is low, that is, reliability that the customer performed the bagging action is low.

In ACT 16, the processor 81 lists “12” as the action status AST in the time-series buffer 822 together with the start time STM, the finish time FTM, and the reliability degree CD. The start time STM is the earliest time TM when “12” was listed in the action file 821 as the action status AST. The finish time FTM is the latest time TM when “12” was listed in the action file 821 as the action status AST. Then, the processor 81 ends the functions of the action recognizing unit 221 and the second acquiring unit 224. If “12” is listed in the time-series buffer 822 as the action status AST, the processor 81 determines YES in ACT 14, skips the processing in ACT 15 and ACT 16, and ends the functions of the action recognizing unit 221 and the second acquiring unit 224.

Usually, the customer registers data of commodities at the self-service POS terminal 11 by repeating the taking-out action and the bagging action on the self-service POS terminal 11 in sequence. Therefore, the action status AST is listed in time series in the time-series buffer 822 generally follows a repeating pattern of “11” then “12”.

Thereafter, if detecting again from a captured video of the camera 21 that a person stands in front of the self-service POS terminal 11, the processor 81 executes the processing in ACT 2 to ACT 16 in the same manner as explained above.

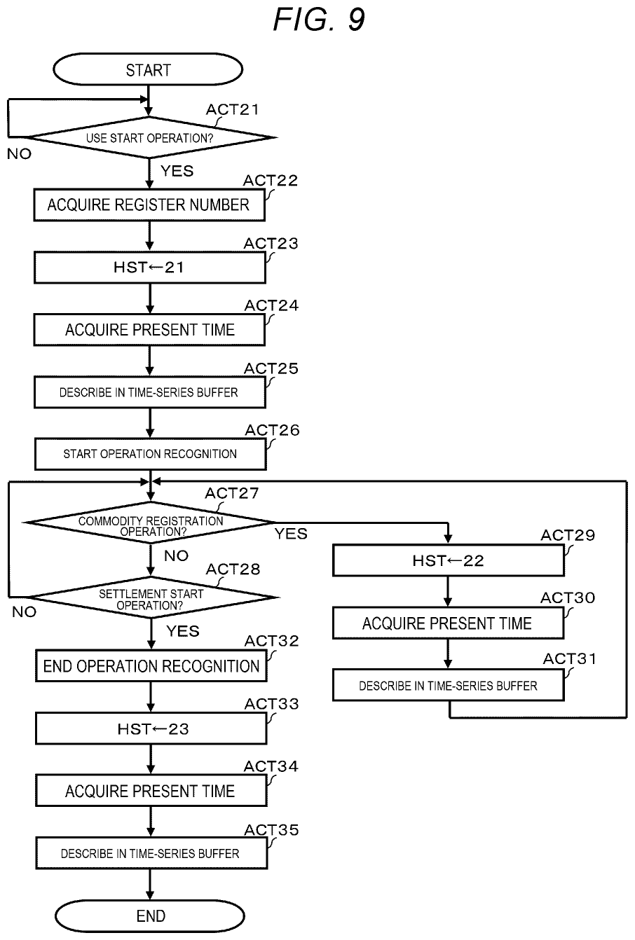

FIG. 9 is a flowchart for explaining the functions of the operation recognizing unit 222 and the first acquiring unit 223.

In ACT 21, the processor 81 waits for a use start to be declared for a self-service POS terminal 11. If the use start is declared for the self-service POS terminal 11, then “use start” will be displayed in the terminal state field 72 of the monitoring image SC corresponding to the self-service POS terminal 11. Thus, the processor 81 checks whether text for “use start” can be recognized in the terminal state field 72 of the monitoring image SC. The information of the terminal state field 72 is acquired via the display control device 13. If the “use start” text is present, the processor 81 recognizes (as a functioning of the operation recognizing unit 222) that the use start has been declared.

If use start is recognized as declared, the processor 81 determines YES in ACT 21 and proceeds to ACT 22. In ACT 22, the processor 81 acquires a register number of the self-service POS terminal 11 for which use start was declared. The register number is displayed in the register number field 71 of the monitoring image SC. Thus, the processor 81 may recognize characters for the register number to be displayed in the register number field 71 of the monitoring image SC, acquired via the display control device 13, as the relevant register number.

In ACT 23, the processor 81 sets the operation status HST to “21”. The operation status HST value “21” indicates a use start operation has been performed. In ACT 24, the processor 81 acquires the present time TM clocked by the timepiece 84. In ACT 25, the processor 81 lists, in the time-series buffer 822 for the register number acquired by the processing in ACT 22, the time TM as the start time STM for the just listed operation status HST “21”. The processor 81 puts NULL values in the finish time FTM and the reliability degree CD at this time.

Therefore, if the customer standing in front of the self-service POS terminal 11 performs a declaration operation for the use start, “21” is first listed in the time-series buffer 822 corresponding to the particular self-service POS terminal 11 (registration No.) along with the present time TM.

In ACT 26, the processor 81 starts operation recognition processing for the self-service POS terminal 11. Specifically, the processor 81 begins to attempt to recognize commodity registration operations and a settlement start operation from changes in the information obtained (by character recognition or the like) from the monitoring image SC (acquired via the display control device 13) to be displayed on the attendant terminal 14.

For example, if detail information such as a commodity name, the number of articles, and an amount of a purchased commodity is added to the details field 75, the processor 81 recognizes that a commodity registration operation has been performed. For example, if the display of the terminal state field 72 is switched to “settlement start” text, the processor 81 recognizes that a settlement start operation has been performed.

In ACT 27 and ACT 28, the processor 81 waits for either a commodity registration operation or a settlement start operation to occur (more particularly, be recognized). If recognizing (as a function of the operation recognizing unit 222) a commodity registration operation while in the waiting state, the processor 81 determines YES in ACT 27 and proceeds to ACT 29.

In ACT 29, the processor 81 (as a function of the first acquiring unit 223) sets the operation status HST to “22”. The operation status HST “22” value indicates a commodity registration operation has occurred (or is occurring). In ACT 30, the processor 81 acquires (as a function of the first acquiring unit 223) the present time TM clocked by the timepiece 84. In ACT 31, the processor 81 lists the time TM as the start time STM along with the operation status HST “22” in the time-series buffer 822. The processor 81 puts NULL values in the finish time FTM and the reliability degree CD at this time. The operation status HST values associated with present time values TM are an example of operation information. After ACT 31, the processor 81 returns to the waiting state (ACT 27 and ACT 28). If recognizing (as a function of the operation recognizing unit 222) the settlement start operation has occurred while in the waiting state, the processor 81 determines YES in ACT 28 and proceeds to ACT 32. In ACT 32, the processor 81 ends the operation recognition for the self-service POS terminal 11.

In ACT 33, the processor 81 sets the operation status HST to “23”. The operation status HST “23” value indicates the settlement start operation has occurred (or been recognized). In ACT 34, the processor 81 acquires the present time TM clocked by the timepiece 84. In ACT 35, the processor 81 lists the time TM as the start time STM for the operation status HST “23” in the time-series buffer 822. The processor 81 lists NULL values in the finish time FTM and the reliability degree CD. Then, the processor 81 ends the functions of the operation recognizing unit 222 and the first acquiring unit 223.

Usually, the customer performs operation for the self-service POS terminal 11 in the order of the use start operation, the commodity registration operation, and the settlement start operation. Therefore, the operation status HST will be listed in the time-series buffer 822 in the order of “21”, “22”, and “23”.

Thereafter, if detecting the use start operation for the self-service POS terminal 11 from data of the monitoring image SC again, the processor 81 executes the processing in ACT 22 to ACT 35 in the same manner as explained above.

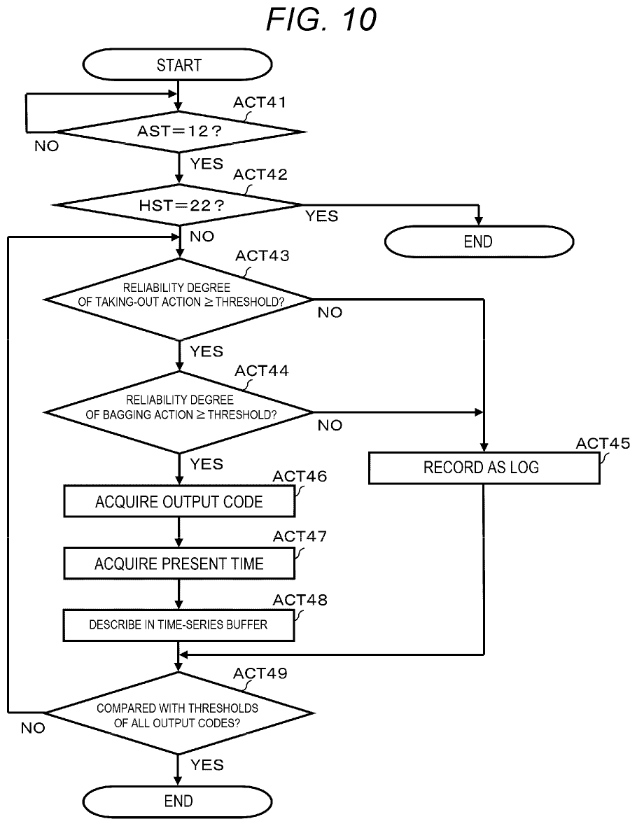

FIG. 10 is a flowchart for explaining the function of the fraudulence estimating unit 225. In this embodiment, the processor 81 executes, for each of purchased commodities, processing of a procedure illustrated in FIG. 10.

In ACT 41, the processor 81 checks whether “12”, that is, the bagging action is described in the time-series buffer 822 as the action status AST. If “12” is described as the action status AST, the processor 81 determines YES in ACT 41 and proceeds to ACT 42.

In ACT 42, the processor 81 checks whether “22” (commodity registration operation) is described as the operation status HST. Specifically, the processor 81 checks whether “22” is listed with the start time STM immediately before the start time STM at which “12” is listed as the action status AST. If “22” is described as the operation status HST, the processor 81 determines YES in ACT 42 and ends the function of the fraudulence estimating unit 225. If “22” is described as the operation status HST, then the action status AST “11”, the operation status HST “22”, and the action status AST “12” will be described in this order in time series in the time-series buffer 822.

If “22” is not described as the operation status HST, the processor 81 determines NO in ACT 42 and proceeds to ACT 43. If “22” is not described as the operation status HST, then the action status AST “11” and the action status AST “12” will be described in this order in time series in the time-series buffer 822.

In ACT 43, the processor 81 checks whether the reliability degree CD in the same row as “11” in the time-series buffer 822) satisfies the threshold of the reliability degree CD for the action status AST “11” listed in the output table 823 for the appropriate output code OC order. If the reliability degree CD of the taking-out action (action status AST “11”) in the time-series buffer 822 does not satisfy the threshold of for the action status AST “11” described in the output table 823, the processor 81 determines NO in ACT 43 and proceeds to ACT 45.

If the reliability degree CD of the taking-out action (action status AST “11”) in the time-series buffer 822 satisfies the threshold of the reliability degree CD described in the output table 823, the processor 81 determines YES in ACT 43 and proceeds to ACT 44.

In ACT 44, the processor 81 checks whether the reliability degree CD in the same row as the action status AST “12” (“bagging action”)in the time-series buffer 822 satisfies the reliability degree CD threshold of the action status AST “12” in the output table 823 for the same output code CC row as the action status AST “11” checked in ACT 43. If the reliability degree CD of the bagging action (action status AST “12”) described in the time-series buffer 822 does not satisfy the threshold of the reliability degree CD in the output table 823, the processor 81 determines NO in ACT 44 and proceeds to ACT 45.

In ACT 45, the processor 81 records the action file 821 and the time-series buffer 822 as a log (journal file) for subsequent review or the like. For example, the processor 81 may store the action file 821 and the time-series buffer 822 in a part of the nonvolatile memory region in the main memory 82. In this case, the main memory 82 is an example of a storing unit. Thereafter, the processor 81 proceeds to ACT 49.

If the reliability degree CD of the bagging action in the time-series buffer 822 satisfies the threshold of the reliability degree CD of the action status AST “12” in the output table 823, the processor 81 determines YES in ACT 44 and proceeds to ACT 46.

In ACT 46, the processor 81 acquires the relevant output code OC. In ACT 47, the processor 81 acquires the present time TM clocked by the timepiece 84. In ACT 48, the processor 81 lists the time TM as the start time STM, and the output code OC (acquired by the processing in ACT 46) in the time-series buffer 822 in correlation with each other. The processor 81 puts NULL values in the finish time FTM and the reliability degree CD at this time.

In ACT 49, the processor 81 checks whether the comparison of the reliability degrees CD of the taking-out action and the bagging action and the thresholds is executed for all of the different output codes OC included the output table 823. If the comparison of the reliability degrees CD of the taking-out action and the bagging action and the thresholds is not yet executed for all of the output codes OC, the processor 81 determines NO in ACT 49 and returns to ACT 43. Thereafter, the processor 81 executes the processing in ACT 43 to ACT 48 in the same manner as explained above for another output code OC (or additional output codes OC).

If the comparison of the reliability degrees CD of the taking-out action and the bagging action and the thresholds has been executed for all of the output codes OC, the processor 81 determines YES in ACT 49 and ends the processing of the fraudulence estimating unit 225.

As explained above, if “22” is not listed as the operation status HST in the time-series buffer 822 or if the reliability degree CD of the taking-out action and the reliability degree CD of the bagging action in the time-series buffer 822 respectively satisfy the thresholds of the reliability degree CD listed in the output table 823, the processor 81 estimates with high reliability that the customer performed a bagging action on a commodity for which the commodity registration operation was not performed. That is, the processor 81 estimates (as a function of the fraudulence estimating unit 225) that an act of the customer is a fraudulent act. In this case, the processor 81 lists, in the time-series buffer 822, the output code OC corresponding to the thresholds of the reliability degree CD from output table 823.

If “22” is not listed in the time-series buffer 822 as the operation status HST but the reliability degree CD of the taking-out action does not satisfy the threshold of the reliability degree CD for the action status AST “11” described in the output table 823 and/or the reliability degree CD of the bagging action does not satisfy the threshold of the reliability degree CD for the action status AST “12” in the output table 823, the processor 81 estimates with low reliability that the customer performed a bagging action for a commodity on which commodity registration operation was not performed. In this case, the processor 81 records the action file 821 and the time-series buffer 822 as a log a no alarm/warning is made.

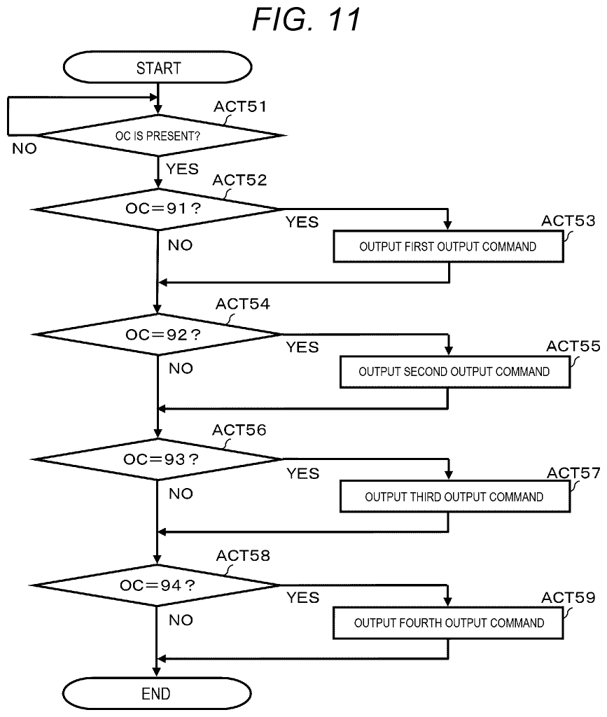

FIG. 11 is a flowchart for explaining the function of the output unit 226.

In ACT 51, the processor 81 waits for an output code OC to be listed in the time-series buffer 822. Until an output code OC is listed in the time-series buffer 822, the processor 81 determines NO in ACT 51. Once an output code OC is listed in the time-series buffer 822, the processor 81 determines YES in ACT 51 and proceeds to ACT 52. In ACT 52, the processor 81 checks whether the output code OC is “91”.

If the output code OC is “91”, the processor 81 determines YES in ACT 52 and proceeds to ACT 53. In ACT 53, the processor 81 outputs a first output command from the communication interface 87 to the self-service POS terminal 11 (as a function of the output unit 226). Specifically, the processor 81 acquires a register number in the time-series buffer 822 for which “91” is listed as the output code OC. The processor 81 acquires the output data (“text data for self-service POS terminal”) in the same row as the output code OC “91” by referring to the output table 823. The first output command includes the register number and the “text data for self-service POS terminal”.

The self-service POS terminal 11 causes the touch panel 41 of the self-service POS terminal 11 identified by the register number included in the first output command to display the “text data for self-service POS terminal”. Thereafter, the processor 81 proceeds to ACT 54.

If the output code OC is not “91”, the processor 81 determines NO in ACT 52 and proceeds to ACT 54. That is, after the processing in ACT 53 or if the output code OC is not “91”, in ACT 54, the processor 81 checks whether the output code OC is “92”.

If the output code OC is “92”, the processor 81 determines YES in ACT 54 and proceeds to ACT 55. In ACT 55, the processor 81 outputs a second output command from the communication interface 87 to the attendant terminal 14 via the display control device 13 (as function of the output unit 226). Specifically, the processor 81 acquires a register number of the time-series buffer 822 in which “92” is listed as the output code OC. The processor 81 acquires the output data (“text data for attendant terminal”) in the same row as the output code OC “92” by referring to the output table 823. The second output command includes the register number and the “text data for attendant terminal”.

The display control device 13 displays the “text data for attendant terminal” on the monitoring image SC of the attendant terminal 14 identified by the register number included in the second output command. Thereafter, the processor 81 proceeds to ACT 56.

If the output code OC is not “92”, the processor 81 determines NO in ACT 54 and proceeds to ACT 56. That is, after the processing in ACT 65 or if the output code OC is not “92”, in ACT 56, the processor 81 checks whether the output code OC is “93”.

If the output code OC is “93”, the processor 81 determines YES in ACT 56 and proceeds to ACT 57. In ACT 57, the processor 81 outputs a third output command from the communication interface 87 to the self-service POS terminal 11 (as a function of the output unit 226). Specifically, the processor 81 acquires a register number of the time-series buffer 822 in which “93” is listed as the output code OC. The processor 81 acquires output data, that is, sound data in the same row as the output code OC “93” by referring to the output table 823. The third output command includes the register number and the sound data.

The self-service POS terminal 11 causes the speaker 85 of the self-service POS terminal 11 identified by the register number included in the third output command to output the sound data. Thereafter, the processor 81 proceeds to ACT 68.

If the output code OC is not “93”, the processor 81 determines NO in ACT 56 and proceeds to ACT 58. That is, after the processing in ACT 57 or if the output code OC is not “93”, in ACT 58, the processor 81 checks whether the output code OC is “94”.

If the output code OC is “94”, the processor 81 determines YES in ACT 58 and proceeds to ACT 59. In ACT 59, the processor 81 outputs a fourth output command from the communication interface 87 to the self-service POS terminal 11 (as a function of the output unit 226). Specifically, the processor 81 acquires a register number of the time-series buffer 822 in which “94” is listed as the output code OC. The processor 81 acquires output data (“color data” in the example) in the same row as the output code OC “94” by referring to the output table 823. The fourth output command includes the register number and the “color data”.

The self-service POS terminal 11 causes the light emitting unit 65 of the self-service POS terminal 11 identified by the register number included in the fourth output command to emit light based on the “color data”. The self-service POS terminal 11 may cause the light emitting unit 65 to selectively emit light of a predetermined color or may cause the light emitting unit 65 to flash. Then, the processor 81 ends the function of the output unit 226.

If the output code OC is not “94”, the processor 81 determines NO in ACT 58 and ends the function of the output unit 226.

As explained above, if recognizing, based on the frame image captured by the camera 21, a taking-out action and a bagging action of a customer who performs the commodity registration operation at the self-service POS terminal 11, the processor 81 of the fraudulent act estimation device 22 calculates the recognition rate RP. The processor 81 lists the time TM, the action status AST, and the recognition rate

RP in the action file 821 to correspond to the frame image. The processor 81 calculates the reliability degrees CD of the taking-out action and the bagging action based on the recognition rate RP in the action file 821. The processor 81 lists the start time STM, the finish time FTM, the action status AST, and the reliability degree CD in the time-series buffer 822. If recognizing the commodity registration operation based on data for the monitoring image SC output from the display control device 13 to the attendant terminal 14, the processor 81 lists the operation status HST and the present time TM as the start time STM, in the time-series buffer 822 as operation information. The processor 81 outputs result information based on the operation information and the reliability degrees CD of the taking-out action and the bagging action.

For example, if “22” is not listed in the time-series buffer 822 and if the reliability degree CD of the taking-out action and the reliability degree CD of the bagging action in the time-series buffer 822 respectively satisfy the thresholds of the reliability degree CD of the action status AST “11” and the reliability degree CD of the action status AST “12” listed in the output table 823 in conjunction with an output code OC, the processor 81 acquires the output code OC and lists the output code OC in the time-series buffer 822 together with the present time TM as the start time STM. The processor 81 may output one or a plurality of output commands including output data corresponding to one or more output codes OC of the output table 823 to the self-service POS terminal 11 or the attendant terminal 14.

For example, if the processor 81 outputs the first output command including the “text data for self-service POS terminal” to the self-service POS terminal 11, text for notifying that a fraudulent act has been detected is displayed on the touch panel 41 of the self-service POS terminal 11. Consequently, it is possible to warn a customer that the fraudulent act suspected (detected) and ask the customer about the situation. As a result, a fraudulent act of the customer at the self-service POS terminal 11 is suppressed.

For example, if the processor 81 outputs the second output command including the “text data for attendant terminal” to the attendant terminal 14, text having content for notifying of a fraudulent act is displayed on the monitoring image SC of the attendant terminal 14. Consequently, the attendant can easily learn of occurrence of the fraudulent act. The attendant can quickly warn the relevant customer and ask the customer about the situation.

As a result, a fraudulent act of the customer on the self-service POS terminal 11 is suppressed.

For example, if the processor 81 outputs the third output command including the sound data to the self-service POS terminal 11, the sound data for informing a fraudulent of the customer is output to the speaker 85 of the self-service POS terminal 11. Consequently, it is possible to warn the customer that a fraudulent act was committed (detected). The attendant who monitors the sound or voice can quickly warn the relevant customer and ask the customer about the situation. As a result, a fraudulent act of the customer on the self-service POS terminal 11 is suppressed.

For example, by outputting the fourth output command including the “color data” to the self-service POS terminal 11, the processor 81 causes the light emitting unit 65 of the self-service POS terminal 11 to emit light to indicate a fraudulent act of the customer based on the “color data” output. Consequently, the attendant who sees the light emission or flashing of the limit emitting unit 65 can quickly warn the relevant customer and ask the customer about the situation. As a result, a fraudulent act of the customer on the self-service POS terminal 11 is suppressed.

As explained above, if it is estimated that reliability that the customer performed the bagging action for a commodity that was taken out by the customer but for which the commodity registration operation was not performed is high, output data is output according to the threshold of the reliability degree CD of the action status AST “11” (taking-out action) and the threshold of the reliability degree CD of the action status AST “12”, (bagging action). The thresholds for output and the output data content can be set in advance by the store. Accordingly, it is possible to set a fraudulent act notification reference, a fraudulent act notification destination, a fraudulent act notification method, and the like according to a policy of the store.

For example, if “22” is not described in the time-series buffer 822 as the operation status HST and if the reliability degree CD of the taking-out action described in the time-series buffer 822 does not satisfy the threshold of the reliability degree CD of the action status AST “11” described in the output table 823 and/or if the reliability degree CD of the bagging action described in the time-series buffer 822 does not satisfy the threshold of the reliability degree CD of the action status AST “12” described in the output table 823, the processor 81 records the action file 821 and the time-series buffer 822 as a log.

As explained above, if it is estimated that reliability that the customer performed the bagging action for a commodity that was taken out by the customer but for which the commodity registration operation was not performed is low, the action file 821 and the time-series buffer 822 are recorded as a log. Since the output data is not output, a normal operation of the customer is not erroneously identified as a fraudulent act and a fraudulent act of the customer is not erroneously determined as a normal act. Accordingly, it is possible to prevent a situation in which, for example, a trouble with the customer occurs or trust in the store is deteriorated. The attendant can later check, by analyzing the log, whether the customer actually committed a fraudulent act. Further, the action file 821 recorded as the log can be used for learning processing for achieving improvement of accuracy of skeleton estimation in a frame image.

Therefore, it is possible to appropriately take measures according to a level of reliability that the customer committed a fraudulent act. An embodiment of a fraudulent act estimation device (and a control program therefor) and a fraudulent act estimation method are explained above. However, the present disclosure is not limited to this.

In an embodiment, the case is illustrated where one camera 21 is disposed for each self-service POS terminal 11.

The camera 21 does not always have to be separately disposed for each of the self-service POS terminals 11. For example, the number of the cameras 21 may be reduced if customers operating two self-service POS terminals 11 adjacent to each other can be imaged by the same camera 21. However, in that case, in ACT 2 in FIG. 8, a register number of the self-service POS terminal 11 closest to the position of a person imaged in a captured video is acquired. In other examples, a plurality of cameras 21 may be disposed for each self-service POS terminal 11. Consequently, it can be possible to reduce blind spots at the self-service POS terminal 11 and more accurately recognize an action of a customer.

In an embodiment, the case is illustrated where the processor 81 extracts the highest recognition rate RP out of one or a plurality of recognition rates RP for which “11” is listed as the action status AST and sets the highest recognition rate RP as the reliability degree CD of the taking-out action. In other examples, if there are a plurality of recognition rates RP at which “11” is listed as the action status AST, the processor 81 may calculate an average value of the plurality of recognition rates RP. The processor 81 may set the average value as the reliability degree CD of the taking-out action. Similarly, about the bagging action, if there are a plurality of recognition rates RP at which “12” is listed as the status ST, the processor 81 may calculate an average value of the plurality of recognition rates RP. The processor 81 may set the average value as the reliability degree CD of the bagging action.

In an embodiment, the taking-out action and the bagging action are illustrated as the actions of the customer that might be recognized. In other examples, the processor 81 may additionally or instead recognize a registering action, a store leaving action, and the like. The registering action is an action of registering data of a commodity taken out from a basket at the self-service POS terminal 11. For example, if detecting a movement of a skeleton of a hand, which performed the taking-out action, holding a purchased commodity over the reading window 42 in the center of the main body 40, the processor 81 recognizes that a registering action is performed. Alternatively, if detecting a movement of a skeleton of one hand operating the touch panel 41 of the main body 40, the processor 81 recognizes that a registering action is performed. The store leaving action is an action of the customer, who presumably finished with settlement, leaves the self-service POS terminal 11. For example, after a skeleton of a hand of the customer, who finished settlement, performs a movement of removing a register bag, a reusable shopping bag, or the like from the holding arms 53, if the customer cannot be detected from a captured video of the camera 21, the processor 81 recognizes that the store leaving action was performed.

In an embodiment, the case is illustrated where the output code OC “92” is for “text data for attendant terminal”.

In other examples, the output code OC “92” may be “text data for attendant terminal” and the “sound data”. In this case, the “text data for attendant terminal” is displayed on the monitoring image SC of the attendant terminal 14 and also a sound is output from a speaker of the attendant terminal 14. The “sound data” may request/instruct, for example, continuous sound or intermittently repeated sound. The “sound data” may request/instruct, for example, a voice output saying, “a fraudulent act was committed in a register with a register No. X”.

For example, the output code OC “95” may be added to the output table 823 in addition to the output code OC “91” to the output code OC “94”. Output data for the output code OC “95” may be, for example, “sound data for attendant terminal”. The “sound data for attendant terminal” is another example of information for making a fraudulent act known. The “sound data for attendant terminal” is another example of the result information. In this case, the output data for the output code OC “93” may be, for example, “sound data for self-service POS terminal”. The “sound data for self-service POS terminal” is another example of information for making a fraudulent act known. The “sound data for self-service POS terminal” is another example of the result information.

In an embodiment, the case is illustrated where the processor 81 stores the action file 821 and the time-series buffer 822 in a part of the nonvolatile memory region in the main memory 82 in order to record the action file 821 and the time-series buffer 822 as a log. In other examples, the processor 81 may transmit the action file 821 and the time-series buffer 822 to the POS server 12 via the communication interface 87. The POS server 12 may store the action file 821 and the time-series buffer 822. The action file 821 and the time-series buffer 822 may be stored in, for example, a memory of an external device communicable connected to the fraudulent act estimation device 22.

In an embodiment, the case is illustrated where, if “22” is not listed in the time-series buffer 822 as the operation status HST and if the reliability degree CD of the taking-out action listed in the time-series buffer 822 does not satisfy the threshold of the reliability degree CD of the action status AST “11” in the output table 823 and/or if the reliability degree CD of the bagging action in the time-series buffer 822 does not satisfy the threshold of the reliability degree CD of the action status AST “12” listed in the output table 823, the processor 81 records the action file 821 and the time-series buffer 822 as a log.

For example, if “22” is not listed in the time-series buffer 822 as the operation status HST and if the reliability degree CD of the taking-out action and the reliability degree CD of the bagging action listed in the time-series buffer 822 respectively satisfy the thresholds of the reliability degree CD of the action status AST “11” and the reliability degree CD of the action status AST “12” listed in the output table 823, the processor 81 may record the action file 821 and the time-series buffer 822 as a log.

In an embodiment, the case is illustrated where the thresholds of the reliability degree CD of the action status AST “11” and the threshold of the reliability degree CD of the action status AST “12” are described in the output table 823. In other examples, the output table 823 may be a data table in which the output code OC, a first threshold of the reliability degree CD of the action status AST “11”, a second threshold of the reliability degree CD of the action status AST “11”, a first threshold of the reliability degree CD of the action status AST “12”, a second threshold of the reliability degree CD of the action status AST “12”, and the output data are listed in correlation with one another.

It is optional how to set the first threshold and the second threshold. The store arbitrarily sets, in advance, the first threshold and the second threshold of the reliability degree CD of the action status AST “11” and the first threshold and the second threshold of the reliability CD of the action status AST “12”.

For example, if “22” is not listed in the time-series buffer 822 as the operation status HST and if the reliability degree CD of the taking-out action and the reliability degree CD of the bagging action described in the time-series buffer 822 respectively satisfy the first threshold of the reliability degree CD of the action status AST “11” and the first threshold of the reliability degree CD of the action status AST “12” listed in the output table 823, the processor 81 may acquire the output code OC and list the output code OC in the time-series buffer 822 together with the present time TM as the start time STM.

For example, if “22” is not listed in the time-series buffer 822 as the operation status HST and if the reliability degree CD of the taking-out action described in the time-series buffer 822 does not satisfy the first threshold but satisfies the second threshold of the reliability degree CD of the action status AST “11” in the output table 823 and/or the reliability degree CD of the bagging action in the time-series buffer 822 does not satisfy the first threshold but satisfies the second threshold of the reliability degree CD of the action status AST “12” in the output table 823, the processor 81 may record the action file 821 and the time-series buffer 822 as a log.

In an embodiment, the attendant terminal 14 may include or incorporate the function of the display control device 13. In this case, the operation recognizing unit 222 acquires data of the monitoring image SC from the attendant terminal 14 and recognizes operation of the customer on the self-service POS terminal 11. Alternatively, the operation recognizing unit 222 may take in, from the communication network 15, for example, via a router, data signals output from the self-service POS terminals 11 and recognize operations of the customer on the self-service POS terminal 11 based on the data signals.

In an embodiment, the case is illustrated where the fraudulent act estimation device 22 includes the functions of the action recognizing unit 221, the operation recognizing unit 222, the first acquiring unit 223, the second acquiring unit 224, the fraudulence estimating unit 225, and the output unit 226. The fraudulent act estimation device 22 may be realized by a system in which functions are distributed across a plurality of devices.

In an embodiment, a skeleton of the customer is estimated from the image captured by the camera 21. The taking-out action and the bagging action of the customer are recognized based on a temporal change of a correspondence relation between the position of the hand based on the skeleton estimation and a region of interest, for example, the position of the main body 40, the bagging table 50, the basket table 60, or the like of the self-service POS terminal 11. However, a method of action recognition is not limited to a method based on skeleton estimation.

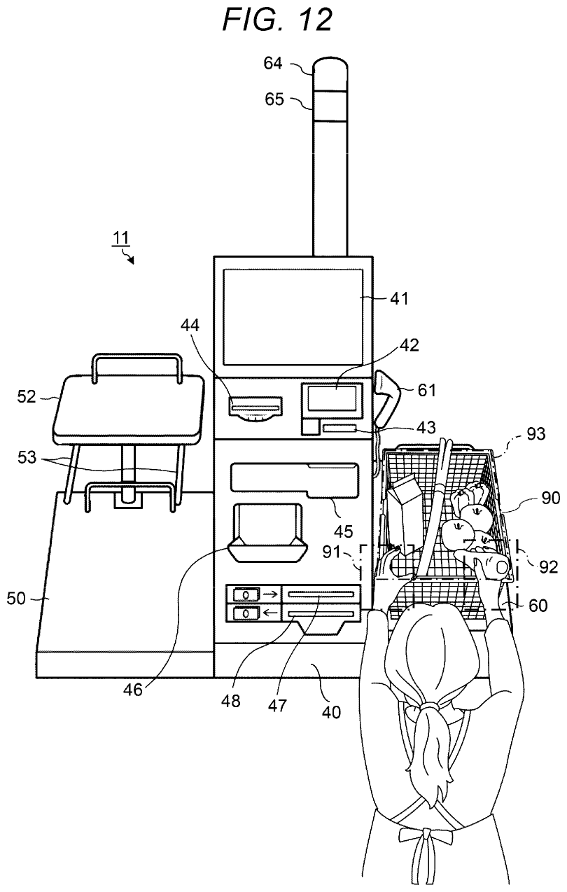

For example, as illustrated in FIG. 12, the processor 81 estimates the left hand and the right hand position of the customer for each of frame image captured by the camera 21 and infers a first bounding box 91 indicating the region of the left hand and a second bounding box 92 indicating the region of the right hand. The processor 81 infers a third bounding box 93 indicating the region of a basket 90 placed on the basket table 60.

The processor 81 selects the bounding box 91 or 92 as the region with a hand holding a commodity. For example, in FIG. 12, the second bounding box 92 is selected. The processor 81 tracks a movement of the selected one of the first or second bounding box 91 or 92 in frame images. The processor 81 sets the third bounding box 93 as a region of interest (ROI). The processor 81 recognizes the taking-out action and the bagging action of the customer from changes over time in the positional relations depicted in the frames according to the movement of the first or second bounding box 91 or 92 and/or a distance between the selected first or second bounding box 91 or 92 and a region of interest.

The region of interest is not limited to the third bounding box 93 indicating the region of the basket 90. For example, the processor 81 may infer a fourth bounding box indicating the region of a register bag, a reusable shopping bag, or the like placed on the bagging table 50 and set the fourth bounding box as the region of interest. The taking-out action and the bagging action of the customer may be recognized from changes over time in positional relations between the first or second bounding box 91 or 92 and the region of interest or movements of the first or second bounding box 91 or 92.

While certain embodiments have been described these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and the equivalents are intended to cover such forms or modifications as would fall within the scope and spirit of the invention.

What is claimed is:

1. A fraudulent act estimation device, comprising:
a first acquiring unit configured to acquire operation information regarding a commodity registration operation at a settlement terminal by a customer based on information supplied from the settlement terminal to a display control device for a monitoring screen displayed on an attendant terminal;
an action recognizing unit configured to recognize actions of the customer who performs the commodity registration operation at the settlement terminal based on image data provided by a camera positioned to monitor the customer at the settlement terminal;
a second acquiring unit configured to calculate a reliability degree for a recognized action of the customer based on a recognition confidence for the recognized action in the image data; and
an output unit configured to output result information based on the operation information and the reliability degree.

2. The fraudulent act estimation device according to claim 1, wherein, if the reliability degree satisfies a predetermined condition, the output unit outputs information for making a fraudulent act known to a display unit of the settlement terminal.

3. The fraudulent act estimation device according to claim 1, wherein, if the reliability degree satisfies a predetermined condition, the output unit outputs information for making a fraudulent act known to a store clerk terminal.

4. The fraudulent act estimation device according to claim 1, wherein, if the reliability degree satisfies a predetermined condition, the output unit outputs sound data for making a fraudulent act known to the settlement terminal.

5. The fraudulent act estimation device according to claim 1, wherein, if the reliability degree satisfies a predetermined condition, the output unit causes a light emitting unit of the settlement terminal to emit light to make a fraudulent act known.

6. The fraudulent act estimation device according to claim 1, wherein, if the reliability degree is less than a threshold value the output unit does not output the result information and stores the operation information and the reliability degree in a storing unit.

7. The fraudulent act estimation device according to claim 1, wherein the action recognizing unit recognizes actions of the customer based on changes in a correspondence relation between an estimated position of a hand of the customer and a position of a region of interest at the settlement terminal.

8. The fraudulent act estimation device according to claim 7, wherein the estimated position of the hand is based on a skeletal estimation of the customer in the image data.

9. The fraudulent act estimation device according to claim 1, wherein the action recognizing unit recognizes actions of the customer based on changes in a correspondence relation between a position of a bounding box indicating a region of a hand of the customer estimated from in the image data and a position of a region of interest at the settlement terminal.

10. A fraudulent act estimation method, comprising:
acquiring operation information regarding a commodity registration operation at a settlement terminal by a customer based on information supplied from the settlement terminal to a display control device for a monitoring screen displayed on an attendant terminal;
recognizing actions of the customer who performs the commodity registration operation at the settlement terminal based on image data provided by a camera positioned to monitor the customer at the settlement terminal;
calculating a reliability degree for a recognized action of the customer based on a recognition confidence for the recognized action in the image data; and
outputting result information based on the operation information and the reliability degree.

11. The fraudulent act estimation method according to claim 10, wherein, if the reliability degree satisfies a predetermined condition, information for making a fraudulent act known is output to a display unit of the settlement terminal.

12. The fraudulent act estimation method according to claim 10, wherein, if the reliability degree satisfies a predetermined condition, information for making a fraudulent act known is output to a store clerk terminal.

13. The fraudulent act estimation method according to claim 10, wherein, if the reliability degree satisfies a predetermined condition, sound data for making a fraudulent act known is output to the settlement terminal.

14. The fraudulent act estimation method according to claim 10, wherein, if the reliability degree satisfies a predetermined condition, a light emitting unit of the settlement terminal is caused to emit light to make a fraudulent act known.

15. The fraudulent act estimation method according to claim 10, wherein, if the reliability degree is less than a threshold value the result information is not output, and operation information and the reliability degree are stored in a storing unit.

16. The fraudulent act estimation method according to claim 10, wherein the actions of the customer are recognized based on changes in a correspondence relation between an estimated position of a hand of the customer and a position of a region of interest at the settlement terminal.

17. The fraudulent act estimation method according to claim 16, wherein the estimated position of the hand is based on a skeletal estimation of the customer in the image data.

18. The fraudulent act estimation method according to claim 10, wherein the actions of the customer are recognized based on changes in a correspondence relation between a position of a bounding box indicating a region of a hand of the customer estimated from in the image data and a position of a region of interest at the settlement terminal.

19. A fraudulent act estimation system, comprising:
a self-service point-of-sale terminal;
an attendant terminal;
a display control device configured to receive operation information from the self-service point-of-sale and generate a monitoring screen corresponding to be displayed on the attendant terminal, the monitoring screen including operation information from the self-service point-of-sale terminal;
a camera positioned to image a customer at self-service point-of-sale terminal; and
a fraudulent act estimation device including:
a first acquiring unit configured to acquire the operation information regarding a commodity registration operation at the self-service point-of-sale terminal by a customer from the display control device;
an action recognizing unit configured to recognize actions of the customer who performs the commodity registration operation at the self-service point-of-sale terminal based on image data provided by the camera;
a second acquiring unit configured to calculate a reliability degree for a recognized action of the customer based on a recognition confidence for the recognized action in the image data; and
an output unit configured to output result information based on the operation information and the reliability degree to at least one of the attendant terminal and the self-service point-of-sale terminal.
